(19) United States
(12) Patent Application Publication
(10) Pub. No.: US 2022/0314887 A1
(43) Pub. Date: Oct. 6, 2022

(54) Truck Bed Ladder Rack

(71) Applicant: Alfonso Arteaga, Chino Hills, CA (US)

(72) Inventor: Alfonso Arteaga, Chino Hills, CA (US)

(21) Appl. No.: 17/698,160

(22) Filed: Mar. 18, 2022

Related U.S. Application Data
(60) Provisional application No. 63/171,396, filed on Apr. 6, 2021.

(51) Int. Cl. B60R 3/00; B60R 9/06

(52) U.S. Cl. CPC B60R 3/007; B60R 9/06

(57) ABSTRACT

A truck bed rack including either a single rack having a mouth for a ladder, or a first rack residing low in the truck bed and having a first mouth for a ladder, and second rack residing between the first rack and the tail gate and having a second mouth higher than the first mouth to angle a ladder to pass above the tail gate. The racks may attach to a fitting sold under the trademark Ford Boxlink attached to a truck bed wall, a track rail sold under the trademark Toyota, a truck bed rail along a top edge of the truck bed side, or include a plate bolted to the truck bed wall. The Boxlink is inverted for use with the truck bed rack.

### CROSS-REFERENCE TO RELATED APPLICATIONS

The present application claims the priority of U.S. Provisional Patent Application Ser. No. 63/171,396 filed Apr. 6, 2021, which application is incorporated in its entirety herein by reference.

### BACKGROUND OF THE INVENTION

The present invention relates transporting material in a truck bed, and in particular to transporting ladders in the truck bed.

Typically, the tallest ladder that fits inside a truck bed is about five feet. Service providers often require taller ladders which extend past a tail gate and may scratch and damage paint. Known ladder racks can carry a taller ladder, but these racks are both unsightly and may prevent entering a parking structure. Ladders may also interfere with a hard truck bed cover. Ladders might lie in the truck bed, but may then either lie on top of tool boxes and parts blocking access, or the tools box and parts on top of the ladder blocking access to the ladder, and may slide out of the truck bed when the truck accelerates. Ladders laying flat in the truck bed often prevent closing the tail gate and if a ladder is tied down against the top edge of the tailgate, it may prevent the tailgate from easily opening.

U.S. Pat. No. 8,820,811 discloses a rack attaching to a truck bed wall and providing supports 14 and 16, but does not attach to common mounting points, and does not provide a natural slope to retain the ladder in the rack. Exposed rivet head of ladders may further catch on shape edges of the rack 10.

### BRIEF SUMMARY OF THE INVENTION

The present invention addresses the above and other needs by providing a truck bed rack including either a single rack having a mouth for a ladder, or a first rack residing low in the truck bed and having a first mouth for a ladder, and second rack residing between the first rack and the tail gate and having a second mouth higher than the first mouth to angle a ladder to pass above the tail gate. The racks may attach to a fitting sold under the trademark Ford Boxlink attached to a truck bed wall, a track rail sold under the trademark Toyota, a truck bed rail along a top edge of the truck bed side, or include a plate bolted to the truck bed wall. The Boxlink is inverted for use with the truck bed rack.

In accordance with one aspect of the invention, there is provided a two piece truck bed rack including an insert which engages an inverted Ford Boxlink. The Ford Boxlink is inverted to position a narrow opening portion at the bottom. A rectangular end of the insert is inserted into a wider top opening and slides down into the narrow opening to engage in the Boxlink.

In accordance with another aspect of the invention, there is provided a two piece truck bed rack providing a slope for retaining ladders in the rack. A first rack includes a first mouth lower than a second mouth in a second rack, mounted behind the first rack. The staggered heights of the racks provides the slope retaining the ladder in the racks and clearance for the ladder above the tail gate.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a truck bed with a two piece truck bed rack according to the present invention supporting a ladder.

FIG. 2A shows a rear view of a first rack of the two piece truck bed rack according to the present invention.

FIG. 2B shows a bed side view of the first rack of the two piece truck bed rack according to the present invention.

FIG. 2C shows a wall side view of the first rack of the two piece truck bed rack according to the present invention.

FIG. 3A shows a rear view of a second rack of the two piece truck bed racks according to the present invention.

FIG. 3B shows a bed side view of the second rack of the two piece truck bed rack according to the present invention.

FIG. 3C shows a wall side view of the second rack of the two piece truck bed rack according to the present invention.

FIG. 4A shows a rear view of a third rack of the truck bed rack according to the present invention.

FIG. 4B shows a bed side view of the third rack of the truck bed rack according to the present invention.

FIG. 4C shows a wall side view of the third rack of the truck bed rack according to the present invention.

FIG. 5A shows a rear view of a fourth rack of the truck bed racks according to the present invention.

FIG. 5B shows a bed side view of the fourth rack of the truck bed rack according to the present invention.

FIG. 5C shows a wall side view of the fourth rack of the truck bed rack according to the present invention.

FIG. 6A shows a rear view of a brace of the truck bed racks according to the present invention.

FIG. 6B shows a top view of the brace of the first and second truck bed racks according to the present invention.

FIG. 7A a rear view of a solid brace of the first and second truck bed racks according to the present invention.

FIG. 7B a top view of the solid brace of the first and second truck bed racks according to the present invention.

FIG. 8 shows a face of an inverted Ford Boxlink.

FIG. 9 shows the truck bed rack attached to the truck bed side by clamping to a truck bed rail according to the present invention.

FIG. 10 shows the truck bed rack attached to the truck bed side by a plate attached to the truck bed side wall according to the present invention.

FIG. 11 shows the truck bed rack attached to the truck bed side by a track rail according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

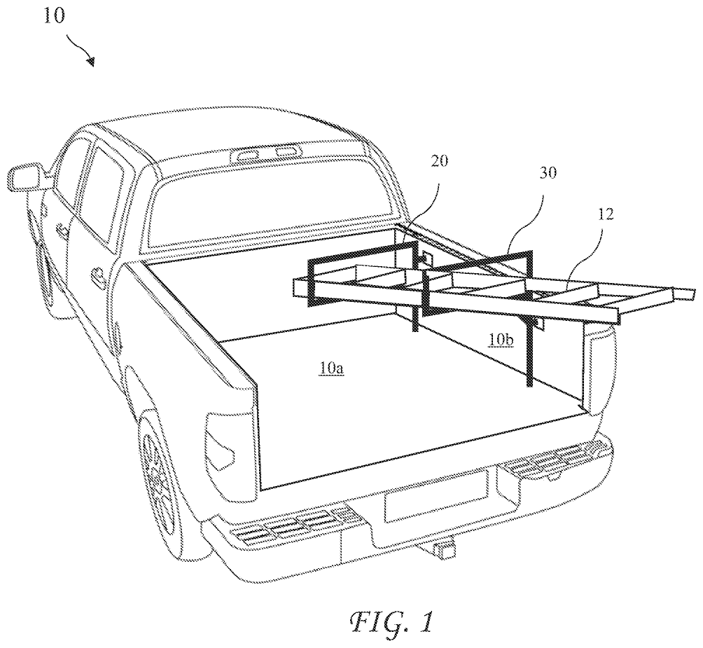

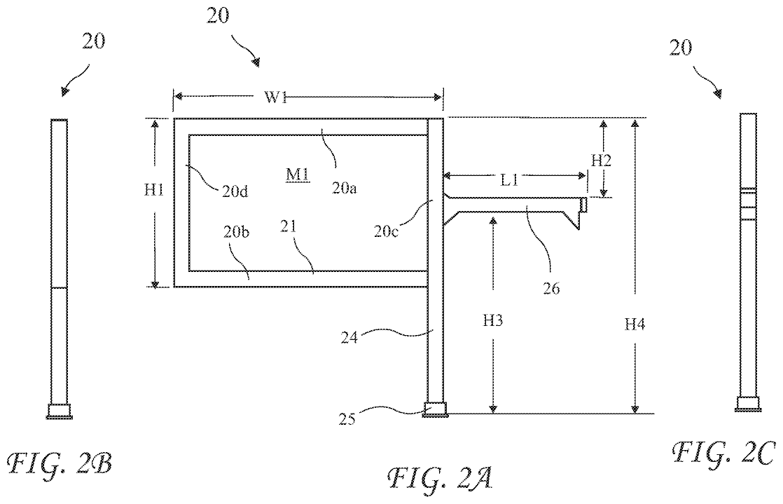

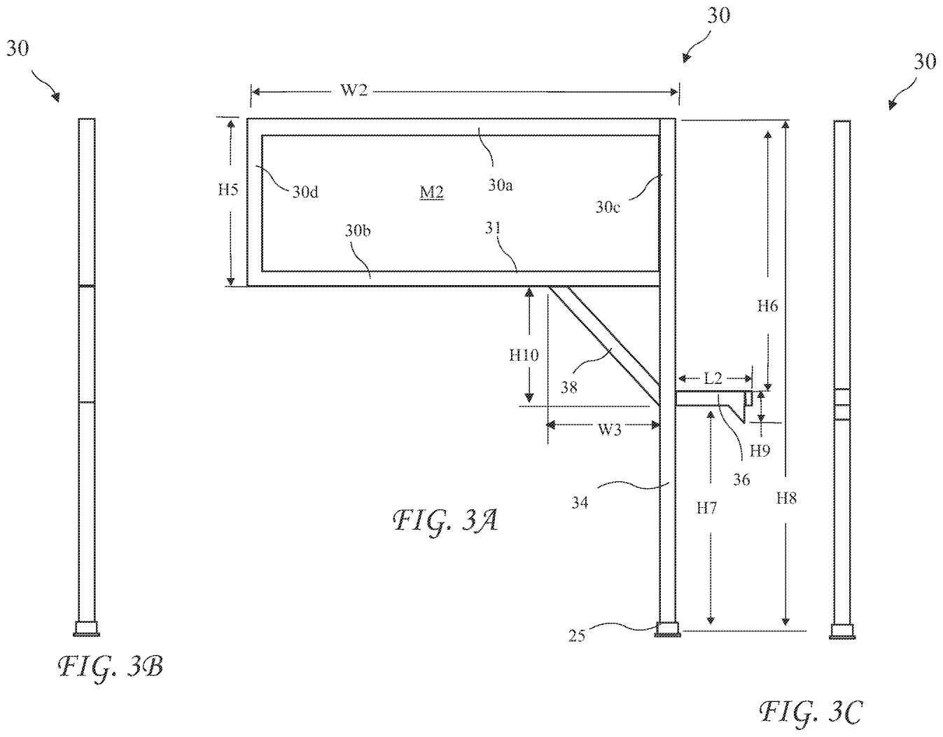

A truck bed 10a of a truck 10 and a first rack 20 and second rack 30 according to the present invention, supporting a ladder 12, are shown in FIG. 1. The second rack 30 is behind the first rack 20 and the second rack 30 includes a mouth M2 (see FIG. 3A) higher than a first mouth M1 (see FIG. 2A) of the first rack 20, providing a slope to retain the ladder 12 in the truck bed 10a.

A rear view (i.e., as viewed from the rear of the truck) of the first rack 20 is shown in FIG. 2A, a bed side view of the first rack 20 is shown in FIG. 2B, and a wall side view of the first rack 20 is shown in FIG. 2C. The first rack 20 has a closed perimeter mouth M1 for receiving the ladder 12. The mouth M1 has a top 20a, bottom, 20b, wall side 20c, and bed side 20d. The mouth M1 has an outside width W1 and an outside height H1. A vertical support 24 is also a right side of the mouth M1 and has a height H4. A horizontal brace 26 reaches from the vertical support 24 to the truck bed side 10b (see FIG. 1) and had a length L1 and is a height H3 above the truck bed 10a and is a height H2 below the top of the mouth M1. A cap 25 resides over the bottom end of the vertical support 24 to prevent damage to the truck bed floor. The cap 25 may be rubber, plastic, PVC or the like.

The width W1 preferably between 15 and 22 inches, is more preferably about 17 inches, and is most preferably 17 inches. The height H1 is preferably between 8 and 14 inches, is more preferably about 10 inches, and is most preferably 10 inches. The height H2 is preferrably between 3 and 12 inches, is more preferably about 4⅜ inches, and is most preferably 4⅜ inches. The height H3 is preferrably between 12 and 18 inches, is more preferably about 13¾ inches, and is most preferably 13¾ inches. The height H4 is preferably between 15 and 30 inches, is more preferably about 19¼ inches, and is most preferably 19¼ inches. The length L1 is preferably between 5 and 9 inches.

A rear view of the second rack 30 of the truck bed racks is shown in FIG. 3A, a bed side view of the second rack 30 is shown in FIG. 3B, and a wall side view of the second rack 30 is shown in FIG. 3C. The second rack 30 has a closed perimeter mouth M2 for receiving the ladder 12. The mouth M2 has an outside width W2 and an outside height H5. A vertical support 34 is also a right side of the mouth M2 and has a height H8. The mouth M2 has a top 30a, bottom, 30b, wall side 30c, and bed side 30d.

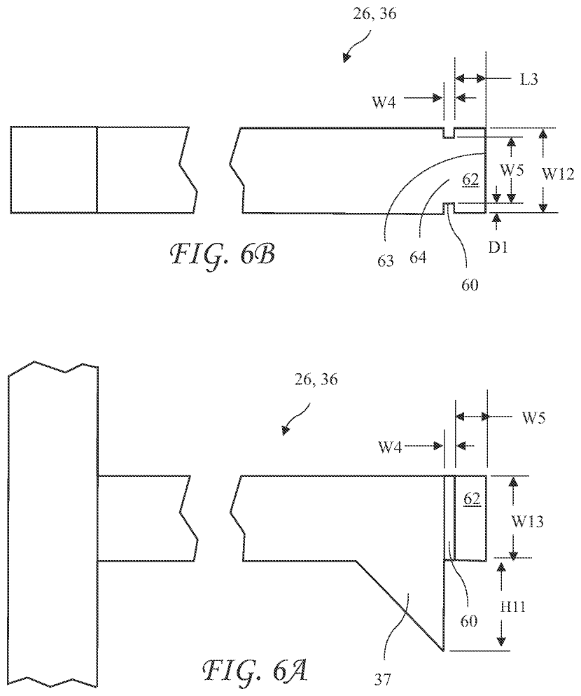

A horizontal brace 36 reaches from the vertical support 34 to the truck bed side 10b (see FIG. 1) and has a length L2, and is a height H7 above the truck bed 10a, and is a height H6 below the top 30a of the mouth M2. The brace 36 preferably has a flared end 37 (see FIG. 6A) configured to reside against the truck bed side 10b the flared end 37 having an overall height H9. A diagonal brace 38 reaches from the vertical support 34 to the bottom 30b of the mouth M2 and has a horizontal width W3 and a height H10.

The width W2 is preferably between 20 and 30 inches, is more preferably about 26 inches, and is most preferably 26 inches. The height H5 is preferably between 8 and 16 inches, is more preferably about 10 inches, and is most preferably 10 inches. The height H6 is preferrably about 16 inches, the height H7 is preferrably about 14 inches, the height H8 is preferably between 26 and 36 inches, is preferably about 31 inches, and is most preferably 31 inches. The height H9 is preferably about 2 inches, and the length L2 is preferably between 3 and 6 inches, is more preferably about 4⅜ inches, and is most preferably 4⅜ inches. The width W3 is preferably about 7 inches and the height H10 is preferably about 7 inches. The diagonal brace 38 is about 10 inches long and at a 45 degree angle.

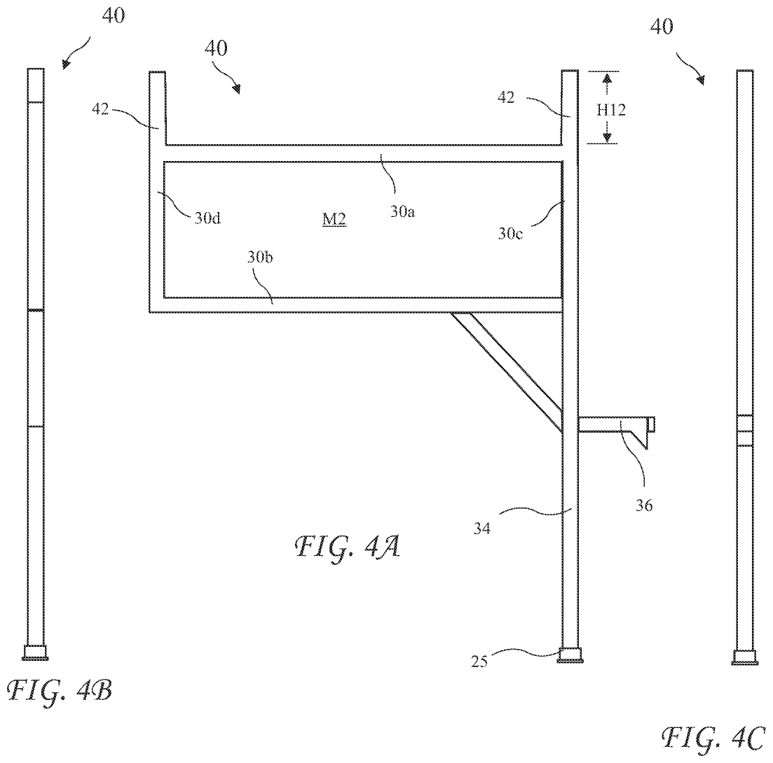

A rear view of a third rack 40 of the truck bed racks is shown in FIG. 4A, a bed side view of the third rack 40 is shown in FIG. 4B, and a wall side view of the third rack 40 is shown in FIG. 4C. The third rack 40 is similar to the second rack 30, but includes vertical extensions 42 rising from the wall side 30c, and bed side 30d allowing carrying a second ladder. The vertical extensions 42 have a height H12 above the top 30a. The height H12 is preferably between 4 and 12 inches and more preferably is about 10 inches.

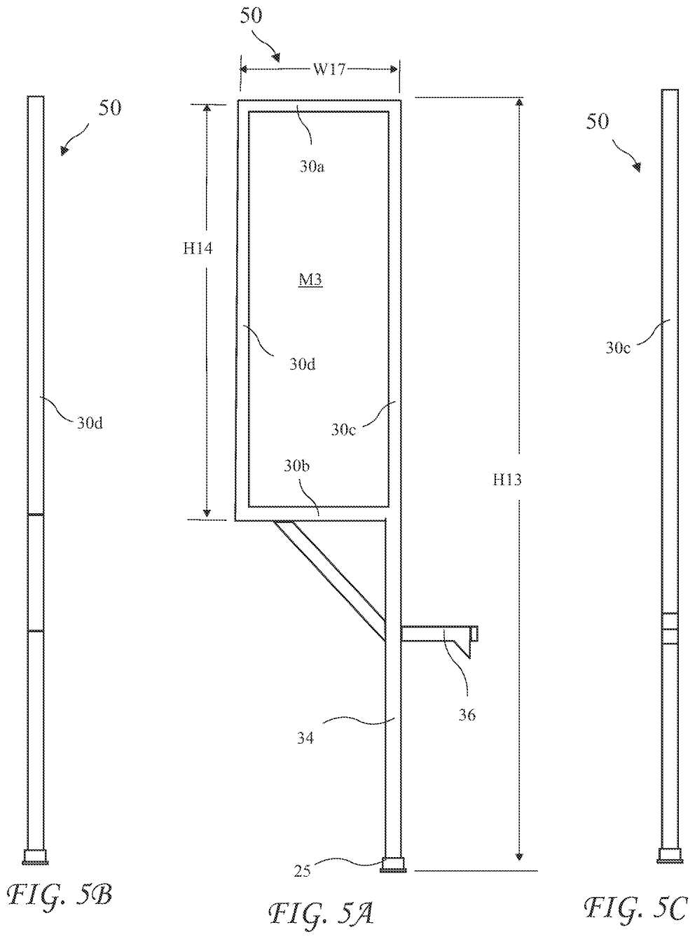

A rear view of a fourth rack 50 of the two piece truck bed racks is shown in FIG. 5A, a bed side view of the fourth rack 50 is shown in FIG. 5B, and a wall side view of the fourth rack 50 is shown in FIG. 5C. The fourth rack 50 includes a mouth M3 configured to hold a ladder on edge. The rack 50 has an overall height H13, the mouth M3 has a height H14 and a width W17. The height H13 is preferably between 38 and 54 inches and more preferably about 50 inches and most preferably is 50 inches. The height H14 is preferably between 24 and 36 inches and more preferably about 26 inches and most preferably is 26 inches. The width W17 is preferably between 10 and 16 inches and more preferably about 12 inches and most preferably is 12 inches.

A rear view of the brace 26 or 36 of the truck bed rack is shown in FIG. 6A and a top view of the brace 26 or 36 is shown in FIG. 6B. The brace 26 or 36 may include a flanged end 37 reaching down a height H11. Grooves 60 on sides of the braces 26 and 36 have a width W4, are a length L3 from a face 63 of an inserted end 62 of the brace 26 or 36, and the grooves 60 have a depth D1. The Grooves 60 form a waist 64 having a width W5. The inserted end 62 is configured to insert into an opening 68 in a reversed Ford Boxlink 66 (see FIG. 8), and to side down to engage the grooves 60 with lips 70 of the Ford Boxlink 66. The brace 26 or 36 is preferably a solid material, and more preferably a solid metal material, and most preferably solid aluminum.

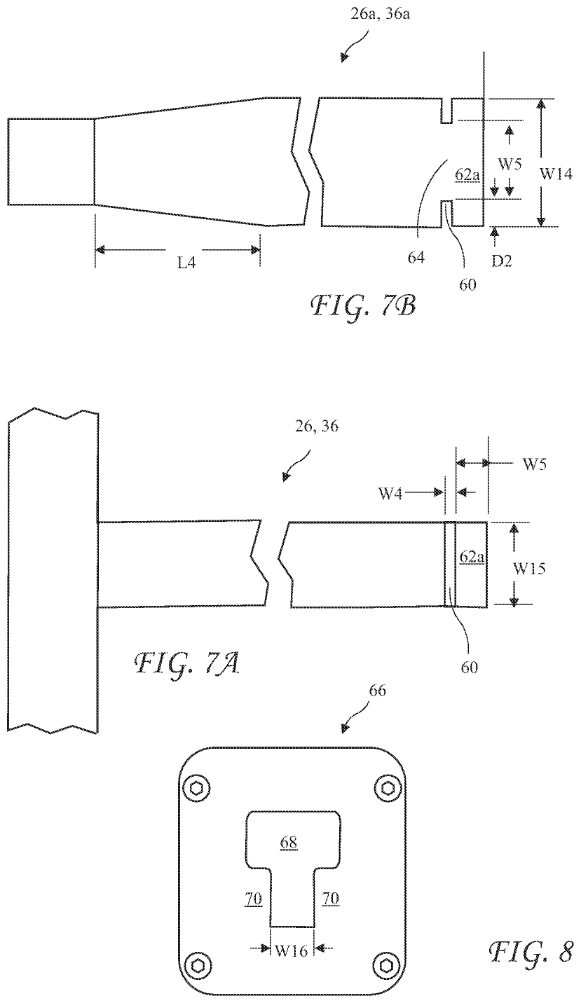

The depth D1 is preferably about 0.1 inches and more preferably is 0.1 inches. The width W4 is preferably about ⅛ inches and more preferably is ⅛ inches, and the length L3 is preferably about ⅜ inches and more preferably is ⅜ inches. The width W5 is preferably about 0.8 inches and more preferably is 0.8 inches. The brace 26 or 36 has a vertical width W13 and a horizontal width W12. The widths W12 and W13 are preferably about 1 inch and more preferably are 1 inch, but the horizontal width W12 may be 1.5 inches at the end 62 and narrow to 1 inch at the vertical support 24 or 34 to add strength (see FIG. 7B). The height H11 is preferably about 0.7 inches and more preferably is 0.7 inches.

Other embodiments of the truck bed rack may have other dimensions, for example, the brace 26, 36 may be between 3 and 12 inches long, the vertical support 24, 34 may reach between 5 to 12 inches below the respective mouths M1, M2, and the mouths M1 and M2 may have inside heights between 8 and 12 inches and inside widths between 12 and 24 inches.

A rear view of a horizontally faired brace 26a or 36a is shown in FIG. 7A and a top view of faired brace 26a or 36a is shown in FIG. 7B. The faired brace 26a or 36a includes an inserted end 62a having a width W14 of preferably about 1.5 inches and more preferably is 1.5 inches. The waste 64 continues to have the width W5, but the grooves 60 have a depth D2 of preferably about 0.35 inches and more preferably is 0.35 inches. The faired brace 26a or 36a tapers from a length L4 from the vertical support 34 from 1.5 inches down to 1 inch. The length L4 is preferably between one and three inches, and m ore preferably about two inches, and most preferably is two inches.

A face of an inverted fitting 66 sold under the trademark Ford Boxlink is shown in FIG. 8. The fitting 66 has right and left lips 70 forming a mouth 68 having a width W16. The width W16 is about 0.8 inches and the inserted end 62 of the rack 20, 30, 40, or 50 is inserted into the opening 68 and down behind the between the lips 70 to install the rack 20, 30, 40, or 50 in the truck bed.

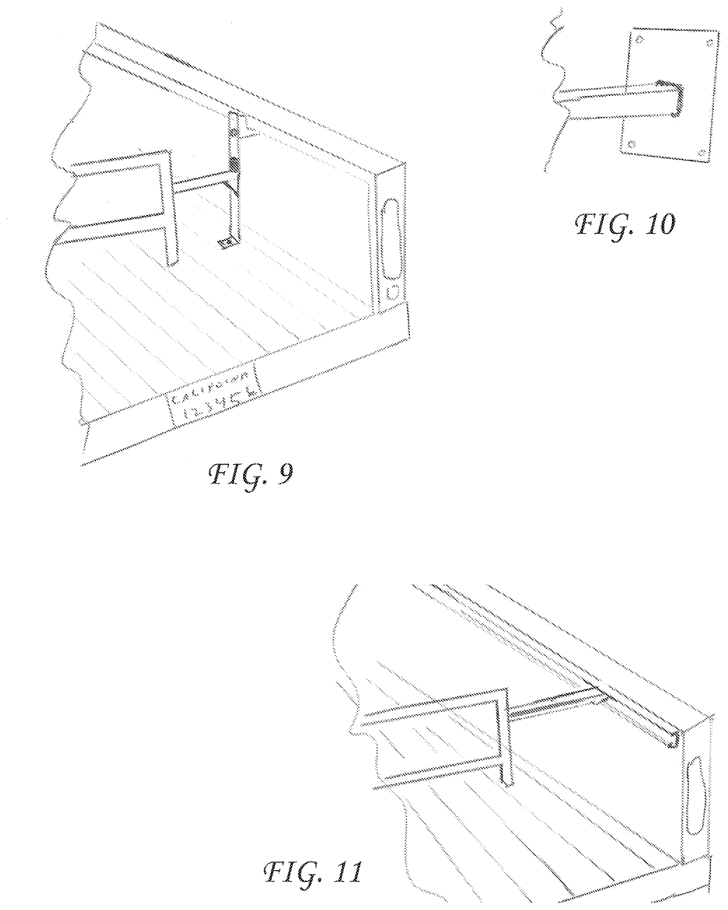

While the present invention has been described as engaging the Ford Boxlink 66, other embodiments may be attached with various features. A truck bed rack attached to the truck bed side by clamping to a truck bed rail is shown in FIG. 9, a truck bed rack attached to the truck bed side by a plate attached to the truck bed side wall is shown in FIG. 10, and a truck bed rack attached to the truck bed side by a track rail is shown in FIG. 11. A truck bed rack described above but having another attaching feature is intended to come within the scope of the present invention.

The racks 20 and 30 are preferably made of 1 inch square material, preferably metal, and more preferably aluminum. The braces 26, 36 are preferably solid material and the remainder square tubing. In some applications the material may be 1.5 inch square material and the material may be rectangular tubing with sides between 1 and 1.5 inches. Edges 21 and 31 (see FIGS. 2A and 3A) in the mouths M1 and M2 preferably has a ¼ inch round. Known ladders 12 include exposed rivets and may catch on a sharp edge. The rack 20, 30, 40, or 50 may be painted, powder coated, anodized, or hot dipped with a coating to avoid damages to articles loaded into the rack, for example surf boards.

While the invention herein disclosed has been described by means of specific embodiments and applications thereof, numerous modifications and variations could be made thereto by those skilled in the art without departing from the scope of the invention set forth in the claims.

I claim:

1. A truck bed rack comprising:
a vertical support configured to rest on a truck bed floor;
a mouth configured to receive a ladder carried in a truck bed, the mouth comprising:
a wall side comprising a portion of the vertical support;
a bottom side reaching horizontally from the vertical support in a mouth direction;
a bed side reaching up from an end of the bottom side opposite to the wall side; and
a top side connecting the bed side to the wall side;
a horizontal brace reaching from the vertical support and opposite to the mouth direction; and
an engaging end of the horizontal brace opposite to the vertical support configured to engage a fitting attached to a truck bed wall.

2. The truck bed rack of claim 1, wherein:
the fitting includes an opening receiving the engaging end of the horizontal brace and lips below the opening reaching in from opposite sides and separated by a gap narrower than the opening; and
the engaging end of the horizontal brace including grooves to engage the lips.

3. The truck bed rack of claim 2, wherein the engaging end of the horizontal brace is about 1.5 inches wide.

4. The truck bed rack of claim 2, wherein:
the vertical support, the bottom side of the mouth, the bed side of the mouth, and the top of the mouth are made from about one inch square tubing;
the horizontal brace has about 1 inch vertical width; and
the horizontal brace tapers to about 1 inch horizontal width where attached to the vertical support.

5. The truck bed rack of claim 4, wherein the truck bed rack is made of metal.

6. The truck bed rack of claim 5, wherein the truck bed rack is made of aluminum.

7. The truck bed rack of claim 2, wherein:
the vertical support, the bottom side of the mouth, the bed side of the mouth, and the top of the mouth are made from about one inch square tubing;
the horizontal brace has about 1 inch horizontal width; and
the engaging end of the horizontal brace includes a bottom vertical taper about starting at 1.7 inches at the groove and tapering to about one inch towards the vertical support.

8. The truck bed rack of claim 2, wherein the truck bed rack has:
an overall height between 26 and 36 inches;
a mouth height between 8 and 16 inches; and
a mouth width between 20 and 30 inches.

9. The truck bed rack of claim 8, wherein the truck bed rack has:
an overall height of about 31 inches;
a mouth height of about 10 inches; and
a mouth width of about 24 inches.

10. The truck bed rack of claim 8, wherein the truck bed rack includes vertical extension extending the vertical support and the bed side between 4 and 12 inches above the top side.

11. The truck bed rack of claim 10, wherein the truck bed rack includes vertical extension extending the vertical support and the bed side about 10 inches above the top side.

12. The truck bed rack of claim 2, further comprising two truck bed racks, a shorter truck bed rack and a higher truck bed rack, the truck bed racks carrying a ladder angled down towards the shorter truck bed rack.

13. The truck bed rack of claim 12, wherein:
the higher truck bed rack has:
a first overall height between 26 and 36 inches;
a first mouth height between 8 and 16 inches;
a first mouth width between 20 and 30 inches; and
a first horizontal brace between 3 and 6 inches long; and
the lower truck bed rack has:
a second overall height between 15 and 30 inches;
a second mouth height between 8 to 14 inches;
a second mouth width between 15 to 22 inches, and
a second horizontal brace between 5 and 8.5 inches long.

14. A truck bed rack comprising:
a vertical support configured to rest on a truck bed floor;
a mouth configured to receive a ladder carried in a truck bed, the mouth comprising:
a wall side comprising a portion of the vertical support;
a bottom side reaching horizontally from the vertical support in a mouth direction;
a bed side reaching up from an end of the bottom side opposite to the wall side; and
a top side connecting the bed side to the wall side;
a horizontal brace reaching from the vertical support and opposite to the mouth direction;
an engaging end of the horizontal brace opposite to the vertical support configured to engage a fitting attached to a truck bed wall, the fitting including an opening receiving the engaging end of the horizontal brace and lips below the opening reaching in from opposite sides and separated by a gap narrower than the opening; and
the engaging end of the horizontal brace including grooves to engage the lips.

15. A truck bed rack comprising:
a vertical support configured to rest on a truck bed floor;
a mouth configured to receive a ladder carried in a truck bed, the mouth comprising:
a wall side comprising a portion of the vertical support;
a bottom side reaching horizontally from the vertical support in a mouth direction;
a bed side reaching up from an end of the bottom side opposite to the wall side; and
a top side connecting the bed side to the wall side;
the vertical support, bottom side, bed side, and top side made of one inch square metal tubing;
a horizontal brace reaching from the vertical support and opposite to the mouth direction, the metal brace made of solid metal tapering to a one inch width at the vertical support;
an engaging end of the horizontal brace opposite to the vertical support configured to engage a fitting attached to a truck bed wall, the engaging end 1½ inches wide, the fitting including an opening receiving the engaging end of the horizontal brace and lips below the opening reaching in from opposite sides and separated by a gap narrower than the opening; and
the engaging end of the horizontal brace including grooves to engage the lips and a waist 0.8 inches wide residing between the lips.
